(19) United States
(12) Patent Application Publication
(10) Pub. No.: US 2021/0200515 A1
(43) Pub. Date: Jul. 1, 2021

(54) SYSTEM AND METHOD TO EXTRACT SOFTWARE DEVELOPMENT REQUIREMENTS FROM NATURAL LANGUAGE

(71) Applicant: Wipro Limited, Bangalore (IN)

(72) Inventors: Rohit Krishna RAYAPATI, Bangalore (IN); Aman CHANDRA, Bangalore (IN)

(21) Appl. No.: 16/798,474

(22) Filed: Feb. 24, 2020

(30) Foreign Application Priority Data
Dec. 31, 2019 (IN) 201941054761

(51) Int. Cl. G06F 8/10; G06F 40/216; G06F 40/284; G06F 16/2452; G06K 9/62; G06K 9/72; G06N 20/20; G06N 3/04

(52) U.S. Cl. CPC G06F 8/10; G06F 40/216; G06F 40/284; G06N 3/0454; G06K 9/6221; G06K 9/723; G06N 20/20; G06F 16/24522

(57) ABSTRACT

The disclosure relates to system and method for extracting software development requirements from natural language information. In one example, the method may include receiving structured text data related to a software development and derived from natural language information, extracting a plurality of features for each sentence in the structured text data, and determining a set of requirement classes and a set of confidence scores for the each sentence, based on the plurality of features, using a set of classification models. The method may further include deriving a final requirement class and a final confidence score for the each sentence based on the set of requirement classes and the set of confidence scores for the each sentence corresponding to the set of classification models, and providing the software development requirements based on the final requirement class and the final confidence score for the each sentence.

### TECHNICAL FIELD

The present disclosure relates generally to software development, and more particularly to system and method for extracting software development requirements from natural language information.

### BACKGROUND

Requirement Elicitation (generally referred as Requirements Gathering) is a critical stage in a software development cycle. Requirements, both functional and non-functional are usually specified in Business Requirement Documents (BRDs). But, other key sources such as webinars, client meetings and audio recordings, business manuals, product documentation, knowledge management systems, and the like, are ignored most of the times. The software development cycle is based upon the extraction and proper understanding of such requirements from the above specified sources (unstructured sources).

Conventional process of extracting and understanding the software development requirements from the unstructured sources is, in the current state of art, completely manual and takes a lot of effort and time of development team. Further, a rigorous process of reading, understanding, analyzing the unstructured sources having different formats of content, and subsequently extracting relevant requirements is time consuming and takes lot of manual effort. Further, the error rate of extraction depends on the human element as well apart from the above-mentioned reasons.

Additionally, the manual process may not be effective because of a combination of reasons such as lack of domain knowledge, human bias while understanding the requirements, difficulty in consolidation of requirements from various sections of the documents, ambiguity in defining the requirements, difficulty in handling various versions of the unstructured sources, and manual errors while capturing requirements. Such challenges may further lead to a domino effect (leading to huge differences between the actual requirements and the capabilities developed), difficulty in management and maintenance of various unstructured sources in the current scenario, difficulty in manually performing a large number of iterations for the extraction process, high errors of omission due to ignoring or missing out some of the requirements (either partially or completely), high errors of commission due to inclusion of incorrect and inaccurate requirements.

In the current state of art, the extraction of software development requirements with contextual information using deep learning models has not yet been performed. It may, therefore, be desirable to use deep learning models to extract software development requirements, and the context for such requirements, from the unstructured sources of information.

### SUMMARY

In one embodiment, a method for extracting software development requirements from natural language information is disclosed. In one example, the method may include receiving, by a requirements extraction device, structured text data related to a software development. The structured text data may be derived from natural language information. The method may further include extracting, by the requirements extraction device, a plurality of features for each of a plurality of sentences in the structured text data. The plurality of features may include at least one of token based patterns, unique words frequency, or word embeddings. The method may further include determining, by the requirements extraction device, a set of requirement classes and a set of confidence scores for each of the plurality of sentences, based on the plurality of features, using a set of classification models. The set of classification models may include at least one of a pattern recognition model, an ensemble model, or a deep learning model. The method may further include deriving, by the requirements extraction device, a final requirement class and a final confidence score for each of the plurality of sentences based on the set of requirement classes and the set of confidence scores for each of the plurality of sentences corresponding to the set of classification models. The method may further include providing, by the requirement extraction device, the software development requirements based on the final requirement class and the final confidence score for each of the plurality of sentences.

In another embodiment, a system for extracting software development requirements from natural language information is disclosed. In one example, the system may include a processor, and a computer-readable medium communicatively coupled to the processor. The computer readable medium may store processor-executable instructions, which when executed by the processor, may cause the processor to receive structured text data related to a software development. The structured text data may be derived from natural language information. The stored processor-executable instructions, on execution, may further cause the processor to extract a plurality of features for each of a plurality of sentences in the structured text data. The plurality of features may include at least one of token based patterns, unique words frequency, or word embeddings. The stored processor-executable instructions, on execution, may further cause the processor to determine a set of requirement classes and a set of confidence scores for each of the plurality of sentences, based on the plurality of features, using a set of classification models. The set of classification models may include at least one of a pattern recognition model, an ensemble model, or a deep learning model. The stored processor-executable instructions, on execution, may further cause the processor to derive a final requirement class and a final confidence score for each of the plurality of sentences based on the set of requirement classes and the set of confidence scores for each of the plurality of sentences corresponding to the set of classification models. The stored processor-executable instructions, on execution, may further cause the processor to provide the software development requirements based on the final requirement class and the final confidence score for each of the plurality of sentences.

In one embodiment, a non-transitory computer-readable medium storing computer-executable instructions for extracting software development requirements from natural language information is disclosed. In one example, the stored instructions, when executed by a processor, may cause the processor to perform operations including receiving structured text data related to a software development. The structured text data may be derived from natural language information. The operations may further include extracting a plurality of features for each of a plurality of sentences in the structured text data. The plurality of features may include at least one of token based patterns, unique words frequency, or word embeddings. The operations may further include determining a set of requirement classes and a set of confidence scores for each of the plurality of sentences, based on the plurality of features, using a set of classification models. The set of classification models may include at least one of a pattern recognition model, an ensemble model, or a deep learning model. The operations may further include deriving a final requirement class and a final confidence score for each of the plurality of sentences based on the set of requirement classes and the set of confidence scores for each of the plurality of sentences corresponding to the set of classification models. The operations may further include providing the software development requirements based on the final requirement class and the final confidence score for each of the plurality of sentences.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for extracting software development requirements from natural language information, in accordance with some embodiments of the present disclosure;

FIG. 2 is a functional block diagram of a requirement extraction device implemented by the exemplary system of FIG. 1, in accordance with some embodiments of the present disclosure.

FIG. 3 is a flow diagram of an exemplary process for extracting software development requirements from natural language information, in accordance with some embodiments of the present disclosure.

FIG. 4 is a flow diagram of an exemplary process for determining a contextual relatedness and a semantic relatedness for a sentence not classified as the software development requirements with respect to neighbouring sentences classified as the software development requirements, in accordance with some embodiments of the present disclosure.

FIG. 5 is a flow diagram of a detailed exemplary process for extracting software development requirements from natural language information, in accordance with some embodiments of the present disclosure.

FIG. 6 is an exemplary table representing confidence scores provided by a pattern recognition model for sentences in structured data, in accordance with some embodiments of the present disclosure.

FIG. 7 is an exemplary table representing confidence scores provided by an ensemble model for the sentences in the structured data, in accordance with some embodiments of the present disclosure.

FIG. 8 is an exemplary table representing confidence scores provided by a deep learning model for the sentences in the structured data, in accordance with some embodiments of the present disclosure.

FIG. 9 is an exemplary table representing a final confidence scores calculated for the sentences in the structured data, in accordance with some embodiments of the present disclosure.

FIG. 10 is an exemplary table representing grouping of sentences belonging to a non-requirement class with sentences belonging to one or more requirement classes so as to provide contextual information, in accordance with some embodiments of the present disclosure.

FIG. 11 is an exemplary table representing a final output of a requirements extraction device of FIG. 1, in accordance with some embodiments of the present disclosure.

FIG. 12 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

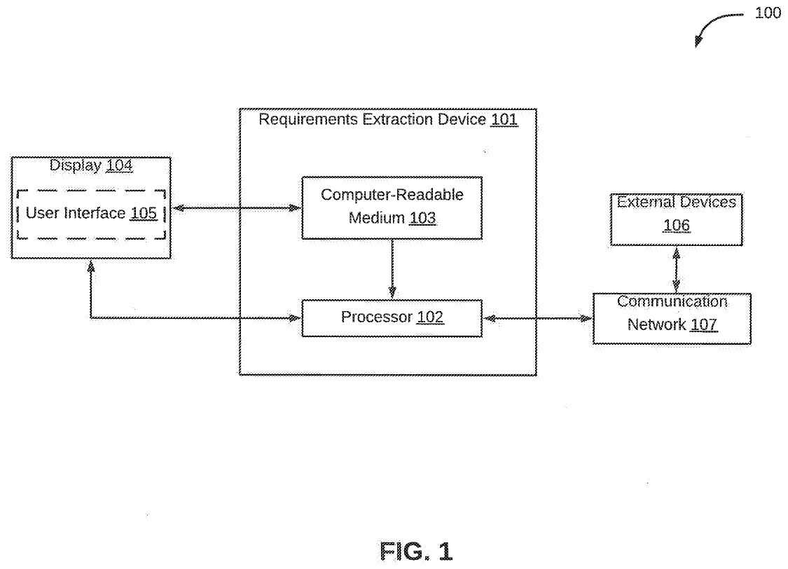

Referring now to FIG. 1, an exemplary system 100 for extracting software development requirements from natural language information is illustrated, in accordance with some embodiments of the present disclosure. As will be appreciated, the system 100 may implement a requirements extraction engine in order to extract software development requirements from natural language information. In particular, the system 100 may include a requirements extraction device 101 (for example, server, desktop, laptop, notebook, netbook, tablet, smartphone, mobile phone, or any other computing device) that may implement the requirements extraction engine. It should be noted that, in some embodiments, the requirements extraction engine may apply at least one of a deep learning model or an ensemble model to the natural language information so as to extract software development requirements and a context for the software development requirements from the natural language information.

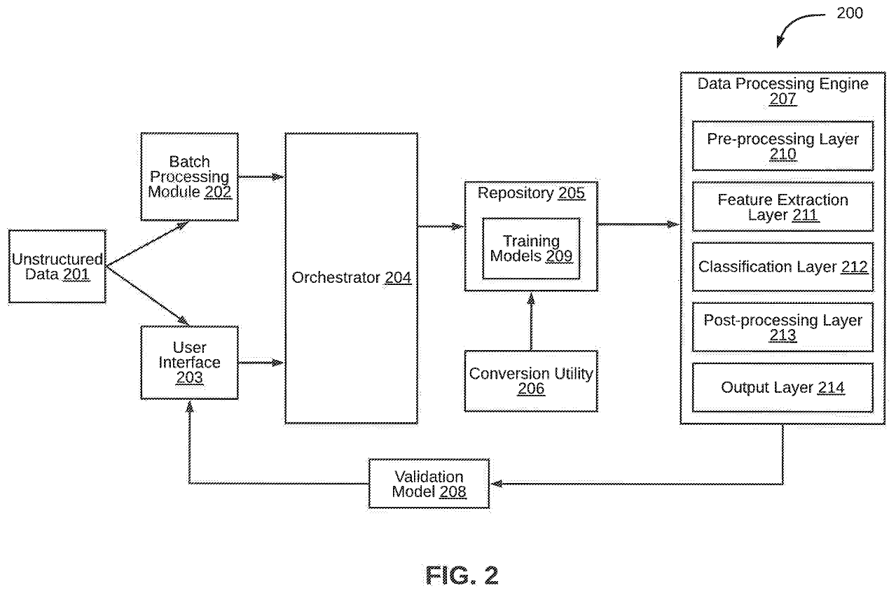

As will be described in greater detail in conjunction with FIGS. 2-11, the requirements extraction device may receive structured text data related to a software development. It may be noted that the structured text data may be derived from natural language information. The requirements extraction device may further extract a plurality of features for each of a plurality of sentences in the structured text data. It may be noted that the plurality of features may include at least one of token based patterns, unique words frequency, or word embeddings. The requirements extraction device may further determine a set of requirement classes and a set of confidence scores for each of the plurality of sentences, based on the plurality of features, using a set of classification models. It may be noted that the set of classification models may include at least one of a pattern recognition model, an ensemble model, or a deep learning model. The requirements extraction device may further derive a final requirement class and a final confidence score for each of the plurality of sentences based on the set of requirement classes and the set of confidence scores for each of the plurality of sentences corresponding to the set of classification models. The requirements extraction device may further provide the software development requirements based on the final requirement class and the final confidence score for each of the plurality of sentences.

In some embodiments, the requirements extraction device 101 may include one or more processors 102 and a computer-readable medium (for example, a memory) 103. The system 100 may further include a display 104. The computer-readable storage medium 103 may store instructions that, when executed by the one or more processors 102, cause the one or more processors 102 to extract software development requirements from natural language information, in accordance with aspects of the present disclosure. The computer-readable storage medium 103 may also store various data (for example, natural language data, structured data, category data, deep learning model data, relatedness data, and the like) that may be captured, processed, and/or required by the system 100. The system 100 may interact with a user via a user interface 105 accessible via the display 104. The system 100 may also interact with one or more external devices 106 over a communication network 107 for sending or receiving various data. The external devices 106 may include, but may not be limited to, a remote server, a digital device, or another computing system.

Referring now to FIG. 2, a functional block diagram of a requirement extraction device 200 (analogous to the requirement extraction device 101 implemented by the system 100) is illustrated, in accordance with some embodiments of the present disclosure. The requirement extraction device 200 may include various modules that perform various functions so as to extract software development requirements from natural language information. In some embodiments, the requirement extraction device 200 may include a batch processing module 202, a user interface (UI) 203, an orchestrator 204, a repository 205, a conversion utility 206, a data processing engine 207, and a validation model 208.

The requirement extraction device 200 may receive unstructured data 201 from one or more data sources. As will be appreciated, the unstructured data may include natural language information. In some embodiments, the unstructured data 201 may be in a text, a video, or an audio format. In some embodiments, the batch processing module 202 may receive the unstructured data 201 from a shared folder. The unstructured data 201 may be processed by the batch processing module 202. In some other embodiments, a user may upload the unstructured data 201 to the UI 203. The UI 203 may allow uploading a plurality of formats of natural language information. It may be noted that the plurality of formats of natural language information may include an audio file, a WebEx recording, a business manual, a business requirement document, a product documentation, and the like. In some embodiments, the UI 203 may include a provision to view and update a plurality of injected sources of information.

The orchestrator 204 regulates a flow of a plurality of requests from the UI 203 to the data processing engine 207. It may be noted that the plurality of requests may include a plurality of user requests or a plurality of system requests. In some embodiments, the orchestrator 204 may regulate the flow of the plurality of requests from the user interface 203 to the data processing engine 207 by communicating and sequencing events between the UI 203 and the data processing engine 207. In some embodiments, the orchestrator 204 may handle parallel processing of the plurality of requests.

The repository 205 may store the unstructured data 201. By way of an example, the repository 205 may be a relational database. It may be noted that the unstructured data 201 may be retrieved through the UI 203. Additionally, the repository 205 may maintain a set of pre-defined text from the conversion utility 206. In some embodiments, the set of pre-defined text may be derived from the natural language information. It may be noted that the data processing engine 207 may use the set of pre-defined text from the repository 205 for data processing. Further, the repository 205 may store a plurality of trained models 209, a plurality of versions of each of the plurality of trained models 209, and a plurality of hyper parameters of each of the plurality of trained models 209. In some embodiments, the repository 205 may allow loading the plurality of trained models 209 into a memory. The conversion utility 206 may convert the unstructured data 201 of a plurality of formats into a predefined text format to obtain a set of pre-defined text. The conversion utility 206 may apply at least one of a video-to-audio extraction, an audio-to-text conversion, or a text-to-text conversion. In some embodiments, the plurality of data formats may include a text (.pdf, .doc, .txt, .csv, and the like), a video, and an audio/speech format. The pre-defined text format is of a standard text format.

The data processing engine 207 processes the set of pre-defined text in order to extract the software development requirements. The data processing engine 207 may include a pre-processing layer 210, a feature extraction layer 211 a classification layer 212, a post-processing layer 213, an output layer 214. The pre-processing layer 210 receives the set of pre-defined text from the conversion utility 206 and performs pre-processing to obtain a structured text data. It may be noted that the pre-processing may include at least one of a text cleaning process, a text standardization process, a text normalization process, a contradiction removal process, an abbreviation removal process, or a named entity replacement process. The feature extraction layer receives the structured text data from the pre-processing layer 210 and extracts a plurality of features from the structured text data. In some embodiments, the plurality of features may include at least one of token based patterns, unique words frequency, or word embeddings.

Further, the classification layer 212 may classify a plurality of sentences in the structured text data into a set of requirement classes, based on the plurality of features extracted by the feature extraction layer 211, using a set of classification models. In some embodiments, the set of classification models may include at least one of a pattern recognition model, an ensemble model, or a deep learning model. As will be appreciated, the ensemble model may be one or more of different machine learning algorithms. Further, in some embodiments, the set of requirement classes may include a functional class, a technical class, a business class, or a non-requirement class. Each of the set of requirement classes other than the non-requirement class may be included in a class of software development requirements.

The post-processing layer 213 provides at least one of a contextual relatedness score and a semantic relatedness score for each of the plurality of sentences not classified as the software development requirements with respect to a set of neighbouring sentences classified as the software development requirements. It should be noted that the semantic relatedness may be employed to determine contextual information with respect to a requirement. Further, the post-processing layer 213 groups one or more of the plurality of sentences not classified as the software development requirements with one or more of the set of neighbouring sentences classified as the software development requirements based on at least one of their contextual relatedness score and their semantic relatedness score. In some embodiments, the at least one of a contextual relatedness score and a semantic relatedness score between two sentences may be determined by applying at least one of a Cosine Similarity algorithm, a Word Mover Distance algorithm, a Universal Sentence Encoder algorithm or a Siamese Manhattan LSTM algorithm, on word embeddings of each of the two sentences. The output layer 214 may receive the software development requirements and contextual information of the structured data from the classification layer 212 and the post-processing layer 213, respectively. The validation model 208 may allow the user to validate or provide feedback through the UI 203 for the software development requirements and the contextual information of the structured data provided by the data processing engine 207.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 102). An identified module of executable code may, for instance, include one or more physical or logical blocks of computer instructions which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for extracting software development requirements from natural language information. For example, the exemplary system 100 and the associated requirement extraction device 101, 200 may extract software development requirements from natural language information by the processes discussed herein. In particular, as will be appreciated by those of ordinary skill in the art, control logic and/or automated routines for performing the techniques and steps described herein may be implemented by the system 100 and the associated requirement extraction device 101, 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

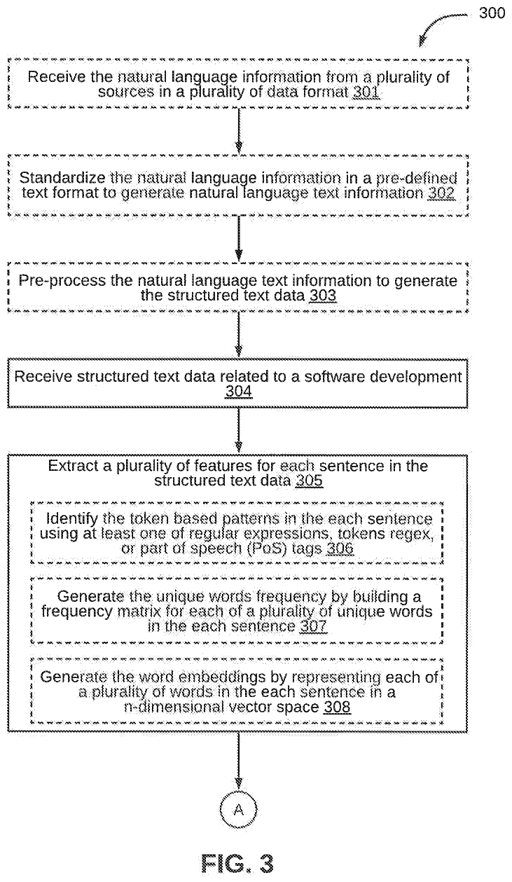

For example, referring now to FIG. 3, an exemplary control logic 300 for extracting software development requirements from natural language information is depicted via a flowchart, in accordance with some embodiments of the present disclosure. The control logic 300 may include receiving the natural language information from a plurality of sources in a plurality of data format, at step 301. It may be noted that the plurality of data format may include at least one of a video format, an audio format, a document format, or a text format. Further, at step 302, the natural language information may be standardized, in a pre-defined text format to generate natural language text information. By way of an example, the standardizing may include at least one of a video-to-audio extraction, an audio-to-text conversion, or a text-to-text conversion. In some embodiments, the step 302 may be performed by the conversion utility 206. At step 303, the natural language text information may be pre-processed, to generate the structured text data. It may be noted that the pre-processing includes at least one of a text cleaning process, a text standardization process, a text normalization process, a contradiction removal process, an abbreviation removal process, or a named entity replacement process. By way of an example, the step 303 may be undertaken at the pre-processing layer 210.

Further, the control logic 300 may include receiving structured text data related to a software development, at step 304. As discussed above, in some embodiments, the structured text data may be derived from natural language information. At step 305, the control logic 300 may include extracting a plurality of features for each of a plurality of sentences in the structured text data. By way of an example, the plurality of features may include at least one of token based patterns, unique words frequency, or word embeddings. In some embodiments, the step 305 of the control logic 300 may include identifying the token based patterns in each of the plurality of sentences using at least one of regular expressions, tokens regex, or part of speech (PoS) tags, at step 306. In some embodiments, the step 305 of the control logic 300 may include generating the unique words frequency by building a frequency matrix for each of a plurality of unique words in each of the plurality of sentences, at step 307. In some embodiments, the step 305 of the control logic 300 may include generating the word embeddings by representing each of a plurality of words in each of the plurality of sentences in a n-dimensional vector space, at step 308. In some embodiments, the step 305 of the control logic 300 may include at least one of the step 306, the step 307, and the step 308. By way of an example, the step 305 may be performed by the feature extraction layer 211.

Further, the control logic 300 may include determining a set of requirement classes and a set of confidence scores for each of the plurality of sentences, based on the plurality of features, using a set of classification models, at step 309. In some embodiments, the set of classification models may include at least one of a pattern recognition model, an ensemble model, or a deep learning model. Additionally, the step 309 of the control logic 300 may include at least one of applying the pattern recognition model on the token based patterns at step 310, applying the ensemble model on the unique words frequency at step 311, and applying the deep learning model on the word embeddings at step 312.

At step 313, a final requirement class and a final confidence score may be derived for each of the plurality of sentences based on the set of requirement classes and the set of confidence scores for each of the plurality of sentences corresponding to the set of classification models. In some embodiments, the final class will be derived based on weighted score of each classification model. In some embodiments, the weights themselves may be dynamically determined based on machine learning based training. Further, in some embodiments, the final predicted class may be considered for the classification model with the highest confidence score. At step 314, the software development requirements may be provided based on the final requirement class and the final confidence score for each of the plurality of sentences. In some embodiments, the steps 309-314 may execute at the classification layer 212.

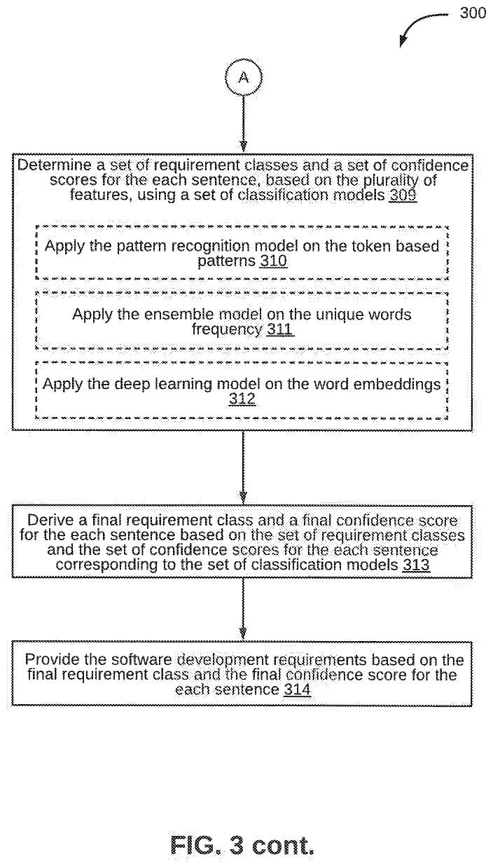

Referring now to FIG. 4, an exemplary control logic 400 for determining a contextual relatedness and a semantic relatedness for a sentence not classified as the software development requirements with respect to neighbouring sentences classified as the software development requirements is depicted via a flowchart, in accordance with some embodiments of the present disclosure. At step 401, the control logic 401 may include determining at least one of a contextual relatedness score and a semantic relatedness score for each of the plurality of sentences not classified as the software development requirements with respect to a set of neighbouring sentences classified as the software development requirements. The determining at least one of a contextual relatedness score and a semantic relatedness score between two sentences of the step 401, may further include on word embeddings of each of the two sentences, applying at least one of a Cosine Similarity algorithm, a Word Mover Distance algorithm, a Universal Sentence Encoder algorithm or a Siamese Manhattan LSTM algorithm, at step 402. At step 403, one or more of the plurality of sentences not classified as the software development requirements may be grouped with one or more of the set of neighbouring sentences classified as the software development requirements based on at least one of their contextual relatedness score and their semantic relatedness score.

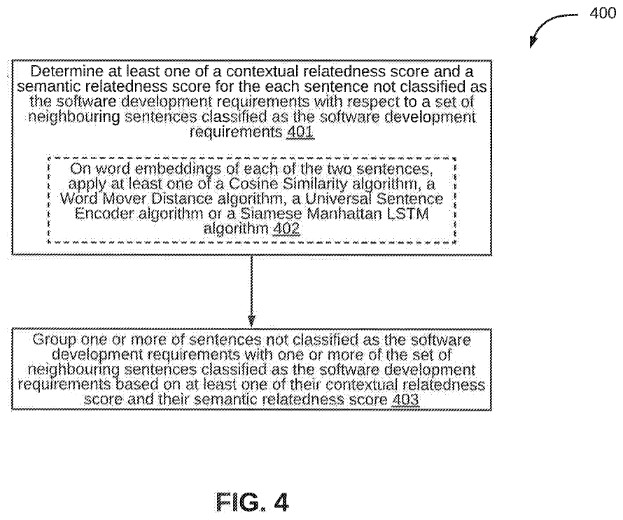

Referring now to FIG. 5, exemplary control logic 500 for extracting software development requirements from natural language information is depicted in greater detail via a flowchart, in accordance with some embodiments of the present disclosure. At step 501, the unstructured data 201, may be accessed, and passed on to the conversion utility 206 and the pre-processing layer 210. In some embodiments, the conversion utility 206 may receive the unstructured data 201 and detect the format of the unstructured data 201. Further, the conversion utility 206 may convert the unstructured data 201 into the set of pre-defined text. In some embodiments, the conversion utility 206 may include a set of conversion modules. By way of an example, the conversion utility 206 may include a speech to text converter, a document format converter, and the like. Further, the set of pre-defined text may be sent to the pre-processing layer 210.

Further, the pre-processing layer 210 may include two stages—a basic text cleaning stage, and a normalization of named entities. In some embodiments, the basic text cleaning stage may include a removal of extra spaces, punctuations, and non-English characters, a conversion of text into common case, a handling of contractions, an identification of parts of speech, a lemmatization, and the like. It may be noted that the basic text cleaning stage is performed to generalize the unstructured data 201 from a large corpus. Further, in some embodiments, the normalization of named entities may include replacing a plurality of named entities in the unstructured data 201 with a set of corresponding categories to provide an equivalent treatment to words with a common context. It may be noted that the plurality of named entities may be a plurality of proper nouns in the unstructured data 201. It may also be noted that the corresponding set of categories may be a set of common nouns. In some embodiments, the plurality of named entities may be replaced with the corresponding set of categories to generalize the unstructured data 201 and enhance the determination of a relatedness information. It may be noted that the pre-processing layer converts the unstructured data 201 into the structured text data. Further, the pre-processing layer 210 may send the structured text data to the feature extraction layer 211.

At step 502, the plurality of features, may be extracted, from the structured text data using the feature extraction layer 211. The plurality of features may be extracted using at least one of identifying the token based patterns, generating the unique words frequency, and generating the word embeddings. In some embodiments, identifying the token based patterns may include finding a set of patterns from the structured text using a plurality of regular expressions, a token regex, or part of speech (PoS) tags, and the like. In some embodiments, generating the unique words frequency may include using a plurality of sentences to form a representation of the unique words of each of the plurality of sentences in the structured text data in a matrix form. It may be noted that the matrix form may be used as a base for the classification layer 212. By way of an example, the unique words frequency may include a term frequency-inverse document frequency (TF-IDF). In some embodiments, generating the word embeddings may include representing English language words in an N-dimensional vector space to perform vector operations. It may be noted that a pre-trained embedding may be publicly available and may be used by the feature extraction layer 211.

At step 503, each of the plurality of sentences in the structured text data may be classified into the set of requirement classes by combination of a set of classification models. In some embodiments, the set of classification models may include a rule-based pattern matching technique, an ensemble model and a state-of-the-art deep learning model. For example, the set of requirement classes may include a functional, a business, a technical, a market, and a system requirement. An example of an ensemble model may be a random forest model. Some examples of a state-of-the-art deep learning model may include an attention-based long short term memory model (LSTM) or an attention-based gated recurrent unit (GRU). It may be noted that classifying the structured text data into the set of requirement classes may help in providing relevant software development requirements to a set of stakeholders involved in software development to fasten a software development cycle. By way of an example, the set of stakeholders may include a business stakeholder, a sales team, a developer, an architect, a production team, a product manager, and the like.

Classifying each of the plurality of sentences in the structured text data into the set of requirement classes may be include at least one of a pattern recognition model, an ensemble model, or a deep learning model. The pattern recognition model may include maintaining a lexicon of a plurality of words which are frequently present in a software development requirement. By way of an example, the plurality of words may include “should be”, “must be”, “could be”, “can”, “shall”, and the like. In some embodiments, the pattern recognition model may use token based patterns identified by the feature extraction layer 211 in order to obtain an improved accuracy. The ensemble model may include a combination of a plurality of decision trees to perform classification or regression with an improved accuracy. In a preferred embodiment, the ensemble model may include a random forest (RF) model and an XGBoost algorithm. It may be noted that an output of the TF-IDF may be sent to the ensemble model for classification of the plurality of sentences in the structured text data.

The deep learning model may include an attention based LSTM. As will be appreciated, an LSTM is a special case of recurrent neural networks (RNN), and is used to retain information of long-term dependencies. As will also be appreciated by a person skilled in the art, the attention based LSTM can learn to prioritize a set of hidden states of the LSTM during a training process, giving high weightage to a part of the plurality of sentences in the structured text data, which is similar or having a similar meaning throughout the training process. It may be noted that the attention-based LSTM may provide an improved accuracy of classification into a functional, a non-functional requirement or a non-requirement. In some embodiments, the confidence scores of each of the set of classification models may be combined for classifying the plurality of sentences of the structured text data into requirements and non-requirements, and further classification of the requirements. It may be noted that a weightage may be given to the confidence scores of each of the set of classification models. In some embodiments, the combination of confidence scores may include an arithmetic average, a weighted average, covering a majority of probabilities given by the set of classification models, or learning the set of weightages using an artificial neural network (ANN) based on a supervised dataset of requirements.

At step 504, relatedness information, may be accessed, of the plurality of sentences extracted and classified as software development requirements using semantic relatedness on the structured text data in the post-processing layer 213. In some embodiments, a plurality of classified sentences are formatted in the post-processing layer 213. As will be appreciated, in a structured text data, there may be sentences before or after the software development requirements, which may reveal contextual information about the software development requirements. The post-processing layer 213 may measure at least one of contextual relatedness score and a semantic relatedness score between two sentences by applying at least one of a set of similarity prediction algorithms. In some embodiments, the set of similarity prediction algorithms may include a Cosine Similarity algorithm, a Word Mover Distance algorithm, a Universal Sentence Encoder algorithm or a Siamese Manhattan LSTM algorithm on word embeddings of each of the two sentences.

It may be noted that the Cosine Similarity algorithm may give a measure of similarity between two sentences based on a cosine of an angle between the word embeddings of each of the two sentences. In some exemplary scenarios, there may be no common words between two sentences. In such scenarios, a Cosine Similarity score may be low. The Word Mover Distance algorithm may include considering a distance between a plurality of words in the word embeddings. It may be noted that when the distance between the word embeddings of each of the two sentences is less, the similarity between sentences is more. As will be appreciated, the Word Mover Distance algorithm may give a better accuracy than the Cosine Similarity algorithm.

As will be appreciated, the Universal Sentence Encoder algorithm is a pre-trained sentence encoder and may produce the word embeddings at a sentence or a document level. In some embodiments, the Universal Sentence Encoder algorithm may play a role analogous to a word2vec or a glove algorithm. It may be noted that similarity determination may be better on a sentence encoder, such as the Universal Sentence Encoder, than on that of word encoders.

As will be appreciated, the Siamese Manhattan LSTM may be used for measuring similarity between two sentence vectors obtained from the Universal Sentence Encoder algorithm. In some embodiments, a set of two inputs may be fed into two identical sub networks and a Manhattan distance may be applied on an output of the two sub networks to determine the similarity between the two sentences. Further, for each of the set of similarity prediction algorithms, the similarity ay be determined between each of the plurality of sentences not classified as the software development requirements with respect to a set of neighbouring sentences classified as the software development requirements. In some embodiments, an output layer 214 may provide the plurality of sentences of the unstructured data 201, classified into a set of software development requirements categories and a contextual Information of each of the software development requirements. The set of software development requirements categories may include a functional requirement, and a non-functional requirement. It may be noted that there may be other categories based on training data provided. The user may provide a feedback or validate the output through the UI 203. As will be appreciated, the feedback may help the system 200 to tune a plurality of parameters for a training process accordingly.

By way of an example, following is a standardized natural language text information converted from natural language information (in one or more data format) 201.
“Currently, BMR receives a processing file from TM1 with the dollar values for off-balance sheet exposures to reallocate in LVE based on joint venture agreements between organizations. This file is made possible only after BMR provides TM1 with the total off-balance sheet exposures by department and cluster level. TM1 applies the JV reallocation percentage between clusters and send BMR the dollar values to reallocate, The reallocated amounts are loaded in LVE by BMR using a manual adjustments template. When the user enters information on the form, the system should perform the validation checks as listed. Each rule will have its own rule id for tracking purposes. When a new rule is created, the following validation criteria must be performed:
a. All MI details should be taken from D_MIS_COB table with the latest COB Date and Run Id
b. The user can select any MI level as the FROM criteria including all the way down to department.”

At the pre-processing layer 210, pre-processing of the standardized natural language text information may be performed to generate the structured text data. The pre-processing may involve text cleaning process, a text standardization process, a text normalization process, a contradiction removal process, an abbreviation removal process, or a named entity replacement process. For example, in the above example, contractions and abbreviations may be removed. Thus,

BMR is replaced with “Basel Measurement and Reporting”;

LVR is replaced with “Leverage Exposure System”;

TM1 is replaced with “IBM COGNOS” (an exemplary product used for modelling of complex financial scenarios);

JV is replaced with Joint Venture; and

Id is replaced with identity.

The standardized natural language text information may yield to following text. It may be noted that the processed abbreviations and contractions are enclosed in parenthesis herein below, for the ease of identification of the pre-processed text. Further, it may be noted that “IBM COGNOS” is just an example and is by no means a requirement for the techniques described in the present disclosure.
“Currently, (Basel Measurement and Reporting) receives a processing file from (IBM COGNOS) with the dollar values for off-balance sheet exposures to reallocate in (Leverage Exposure System) based on joint venture agreements between organizations.
This file is made possible only after (Basel Measurement and Reporting) provides (IBM COGNOS) with the total off-balance sheet exposures by department and cluster level.
(IBM COGNOS) applies the Joint Venture reallocation percentage between clusters and send (Basel Measurement and Reporting) the dollar values to reallocate.
The reallocated amounts are loaded in (Leverage Exposure System) by (Basel Measurement and Reporting) using a manual adjustments template.

When the user enters information on the form, the system should perform the validation checks as listed.
Each rule will have its own rule identity for tracking purposes.
When a new rule is created, the following validation criteria must be performed:
All MI details should be taken from D_MIS_COB table with the latest COB Date and Run Identity
The user can select any MI level as the FROM criteria including all the way down to department.”

Further, Named Entity Replacement (NER) process may be performed on the above text as input to generate structured text data. Thus, the named entities in the above text may be replaced with a set of categories to obtain the structured text. The set of categories may be common nouns (e.g., organization, product, etc.) and may be used for improved determination of context. It may be noted that the processed named entities are enclosed in parentheses herein below, for the ease of identification of the pre-processed text.
“Currently, (product) receives a processing file from (organization) (product) with the dollar values for off-balance sheet exposures to reallocate in (product) based on joint venture agreements between organizations.
This file is made possible only after (product) provides (organization) (product) with the total off-balance sheet exposures by department and cluster level.
(organization) (product) applies the Joint Venture reallocation percentage between clusters and send (product) the dollar values to reallocate.
The reallocated amounts are loaded in (product) by (product) using a manual adjustments template.
When the user enters information on the form, the system should perform the validation checks as listed.
Each rule will have its own rule identity for tracking purposes.
When a new rule is created, the following validation criteria must be performed:
All MI details should be taken from D_MIS_COB table with the latest COB Date and Run identity.
The user can select any MI level as the FROM criteria including all the way down to department.”

Further, the above structured text may be sent to the feature extraction layer 211. It may be noted that following features (e.g., token based patterns, the TF-IDF, and the word embeddings) may be extracted from the structured text:

Token based Patterns:
Sample phrases: ‘can be’, ‘should b’e, ‘must be’, ‘could be’ TF-IDF:’
Build a matrix of unique words against documents.
If there are 150 unique words and 9 sentences.
Matrix's dimension would be 150*9.

Word Embeddings:
Each word in a sentence is represented in n-dimensions(n-dim) with m as the sequence length(m-seq).
So, each will become a matrix of n*m
In total it will become (number of sentences*n-dim*m-seq)

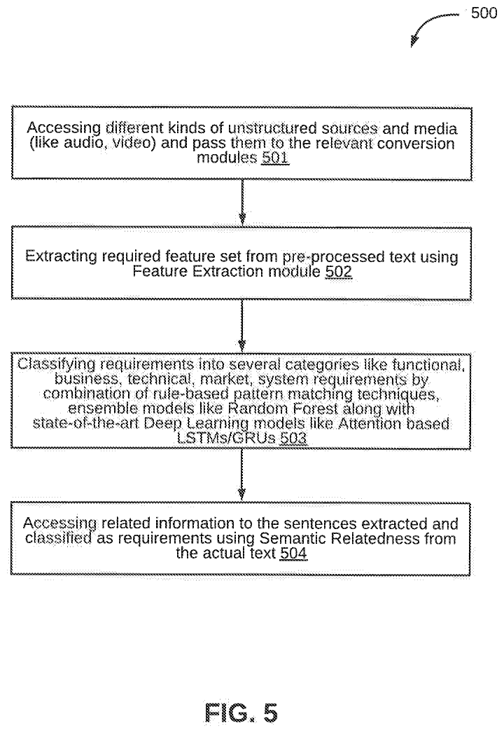

By way of an example, referring now to FIG. 6, an exemplary table 600 representing confidence scores provided by a pattern recognition model for a plurality of sentences 601 in structured data is illustrated, in accordance with some embodiments of the present disclosure. The table 600 includes entries for a plurality of sentences 601 of the structured data, a confidence score 602 for each of the classification of the pattern recognition model, and a class 603 determined by the pattern recognition model. It may be noted that a class may not be provided for the pattern recognition model and an output for the confidence score 602 may be either 0 or 1. It may also be noted that the pattern recognition model may be a binary classifier, providing the confidence score 602 as “true” (1) or “false” (0).

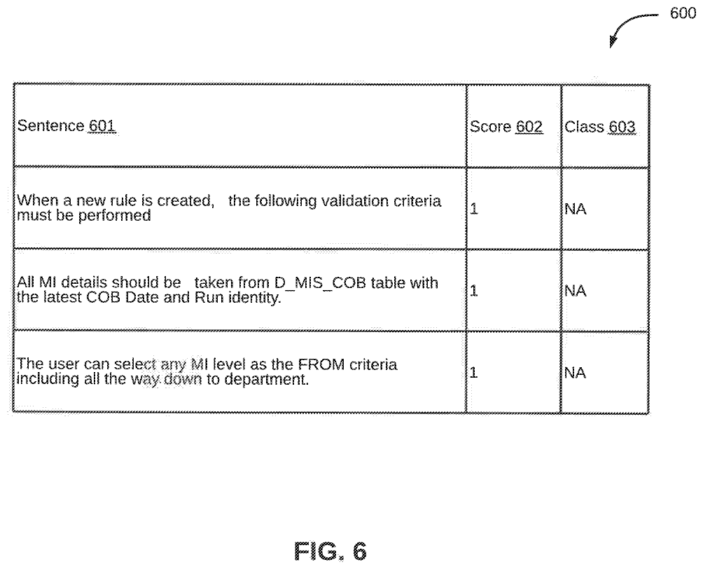

Referring now to FIG. 7, an exemplary table 700 representing confidence scores provided by an ensemble model for the plurality of sentences 701 in the structured data is illustrated, in accordance with some embodiments of the present disclosure. The table 700 includes entries for a plurality of sentences 701 of the structured data, a confidence score 702 for each of the classification of the ensemble model, and a class 703 determined by the ensemble model. It may be noted that the confidence score 702 may be a probability score. In some embodiments, a set of values for the class 703 may include a technical, a non-technical, a functional, a non-functional, a “not a requirement”, and the like. In such embodiments, a sentence may be classified as “not a requirement” when the confidence score 702 of the sentence may be less than a pre-defined threshold value.

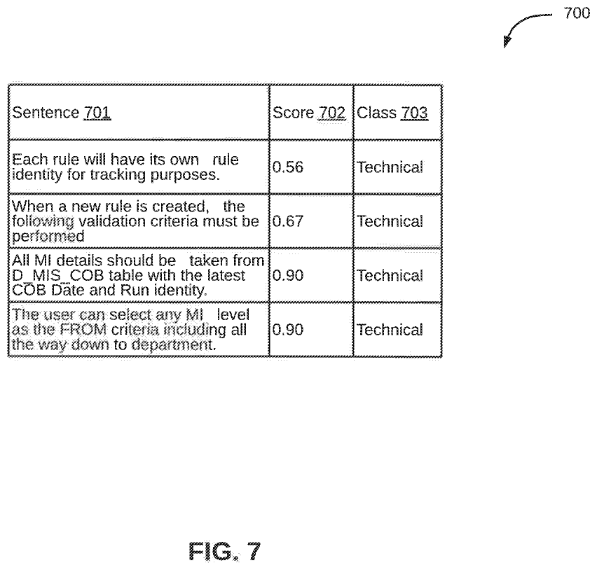

Referring now to FIG. 8, an exemplary table 800 representing confidence scores provided by a deep learning model for the plurality of sentences 801 in the structured data is illustrated, in accordance with some embodiments of the present disclosure. The table 800 includes entries for a plurality of sentences 801 of the structured data, a confidence score 802 for each of the classification of the deep learning model, and a class 803 determined by the pattern recognition model. It may be noted that the confidence score 802 may be a probability score. In some embodiments, a set of values for the class 803 may include a technical, a non-technical, a functional, a non-functional, a “not a requirement”, and the like. In such embodiments, a sentence may be classified as “not a requirement” when the confidence score 802 of the sentence may be less than a predefined threshold value. The table 800 also includes an uncovered sentence 804 which was not retrieved by the pattern recognition model or the ensemble model. It may be noted that the uncovered sentence 804 implies an added advantage of using the set of classification models in combination.

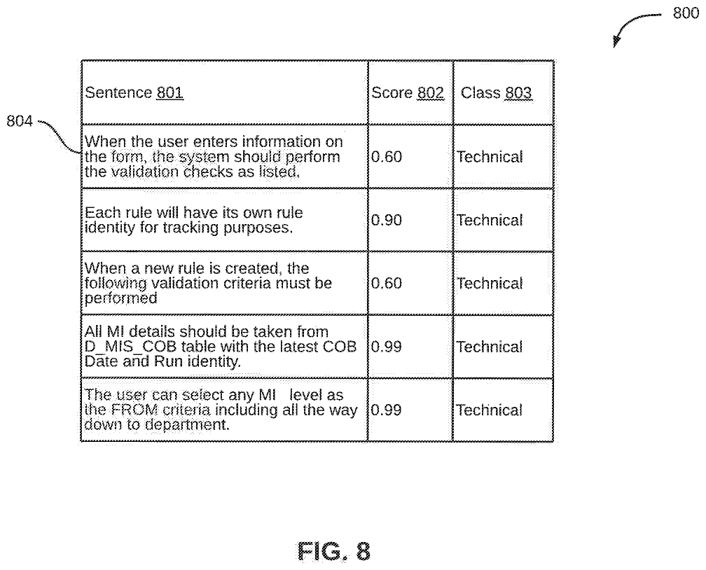

Referring now to FIG. 9, an exemplary table 900 representing a final confidence scores calculated for the plurality of sentences 901 in the structured data is illustrated, in accordance with some embodiments of the present disclosure. The table 900 includes entries for a plurality of sentences 901 of the structured data, a score weightage 902 for the confidence score of each of the set of classification models, a combined confidence score 903 calculated using the score weightage 902, and a class 904 determined by combining each of the set of classification models. In some embodiments, the score weightage 902 for the confidence score of each of the set of classification models may be a pre-defined weightage, a user-defined weightage, or calculated using an artificial neural network (ANN) model. By way of an example, a combined confidence score using a pre-defined weightage for the confidence score of each of the set of classification models may be:

Final Score=0.25*Knowledge based Pattern Recognition+0.25*Ensemble model+0.50*LSTM with attention (1)

It may be noted that the combined confidence score 903 may be a probability score. In some embodiments, a set of values for the class 904 may include a technical, a non-technical, a functional, a non-functional, a “not a requirement”, and the like. In such embodiments, a sentence may be classified as “not a requirement” when the combined confidence score 903 of the sentence may be less than a pre-defined threshold value.

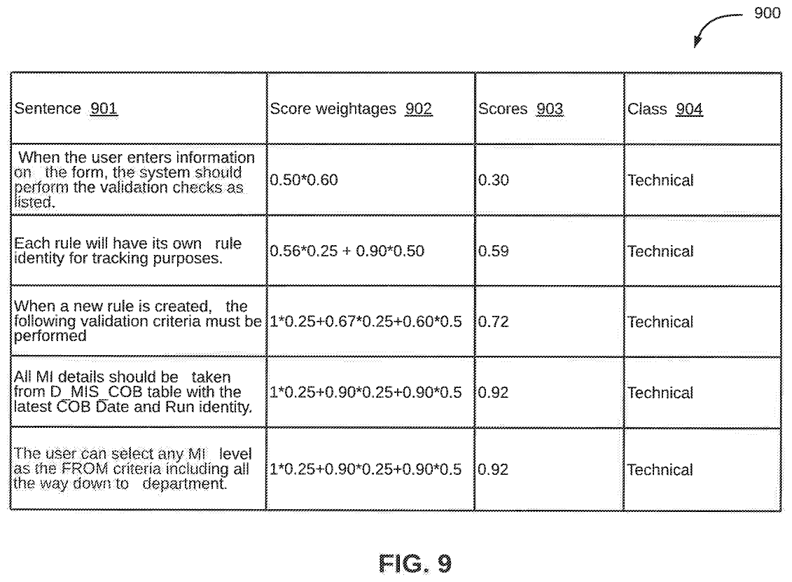

Referring now to FIG. 10, an exemplary table 1000 representing grouping of sentences belonging to a non-requirement class with sentences belonging to one or more requirement classes so as to provide contextual information is illustrated, in accordance with some embodiments of the present disclosure. The table 1000 includes a sentence 1001 belonging to a non-requirement class, based on the combined confidence score 903, grouped with the software development requirements to provide contextual information.

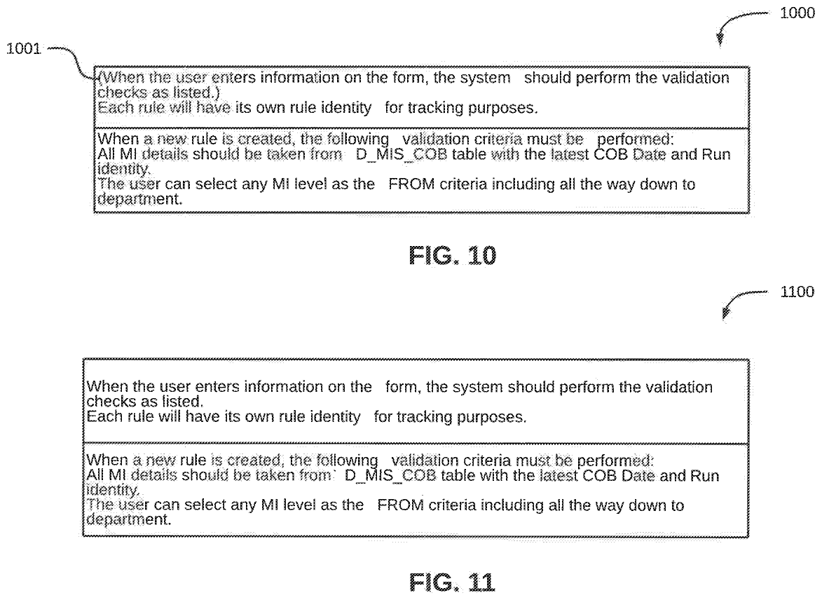

Referring now to FIG. 11, an exemplary table 1100 representing a final output of a requirements extraction device 200 is illustrated, in accordance with some embodiments of the present disclosure. The table 1100 may include the software development requirements and each of a plurality of sentences classified as a non-requirement grouped together to provide software development requirements with a context.

As will be appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

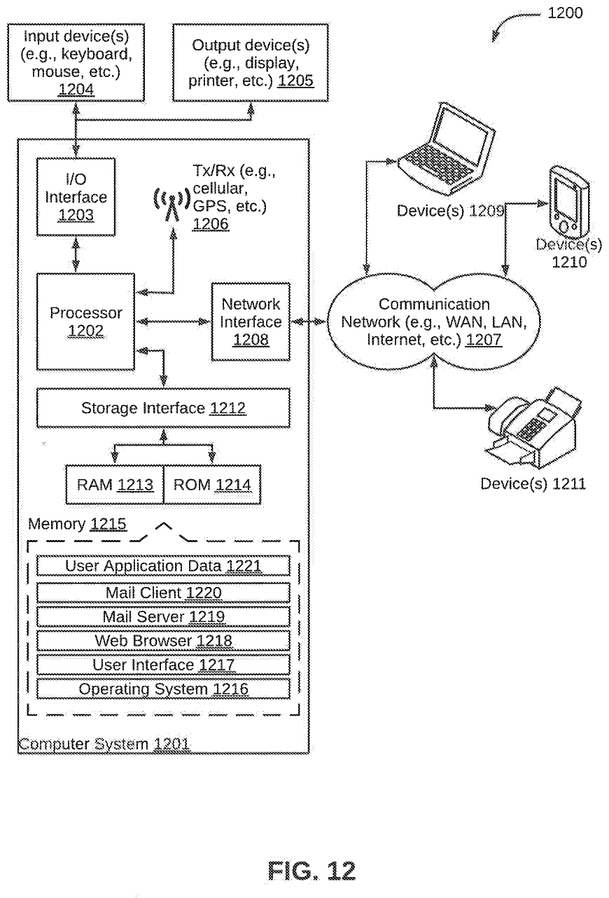

The disclosed methods and systems may be implemented on a conventional or a general-purpose computer system, such as a personal computer (PC) or server computer. Referring now to FIG. 12, a block diagram of an exemplary computer system 1201 for implementing embodiments consistent with the present disclosure is illustrated. Variations of computer system 1201 may be used for implementing system 100 for extracting software development requirements from natural language information. Computer system 1201 may include a central processing unit (“CPU” or “processor”) 1202. Processor 1202 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 1202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1202 may be disposed in communication with one or more input/output (I/O) devices via I/O interface 1203. The I/O interface 1203 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RE) antennas, S-Video, video graphics array (VGA), IEEE 802.n /b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1203, the computer system 1201 may communicate with one or more I/O devices. For example, the input device 1204 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1205 may be a printer, fax machine, video display (e.g., cathode ray tube (CRT), liquid crystal display (LCD), light-emitting diode (LED), plasma, or the like), audio speaker, etc. In some embodiments, a transceiver 1206 may be disposed in connection with the processor 1202. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 1202 may be disposed in communication with a communication network 1208 via a network interface 1207. The network interface 1207 may communicate with the communication network 1208. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1208 may include, without limitation, a direct interconnection, local area network (LAN), wide area network (WAN), wireless network (e.g., using Wireless Application Protocol), the Internet, etc. Using the network interface 1207 and the communication network 1208, the computer system 1201 may communicate with devices 1209, 1210, and 1211. These devices may include, without limitation, personal computer(s), server(s), fax machines, printers, scanners, various mobile devices such as cellular telephones, smartphones (e.g., APPLE® PHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 1201 may itself embody one or more of these devices.

In some embodiments, the processor 1202 may be disposed in communication with one or more memory devices (e.g., RAM 1213, ROM 1214, etc.) via a storage interface 1212. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 1216, user interface application 1217, web browser 1218, mail server 1219, mail client 1220, user/application data 1221 (e.g., any data variables or data records discussed in this disclosure), etc. The operating system 1216 may facilitate resource management and operation of the computer system 1201. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 1217 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 1201 may implement a web browser 618 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 1201 may implement a mail server 1219 stored program component. The mail server may be an Internet mail server such as MICROSOFT® EXCHANGE®, or the like. The mail server may utilize facilities such as ASP, ActiveX, ANSI C++C#, MICROSOFT .NET® CGI scripts. JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 1201 may implement a mail client 1220 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 1201 may store user/application data 1221, such as the data, variables, records, etc. (e.g., unstructured data, natural language text information, structured text data, sentences, extracted features (token based patterns, unique words frequency, word embeddings, etc.), classification models (pattern recognition model, ensemble model, deep learning model, etc.) requirement classes, confidence scores, final requirement classes, final confidence scores, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above are not routine, or conventional, or well understood in the art. The techniques discussed above provide for extracting software development requirements from natural language information. The techniques employ deep learning models in order to achieve the same. The deep learning models help in extracting software development requirements from a plurality of text, video, and audio sources in a plurality of file formats and, therefore, help accurate and relevant determination of software development requirements. Further, the application of deep learning models may significantly cut the number of interactions required and the number of clarifications sought at each stage of a software development cycle. Further, a plurality of file formats such as video, audio, Webex. documents, call recordings, and the like, may be processed at a faster rate than manual processing.

The specification has described a system and method to extract software requirements from natural language using deep learning models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for extracting software development requirements from natural language information, the method comprising:
receiving, by a requirements extraction device, structured text data related to a software development, wherein the structured text data is derived from natural language information;
extracting, by the requirements extraction device, a plurality of features for each of a plurality of sentences in the structured text data, wherein the plurality of features comprise at least one of token based patterns, unique words frequency, or word embeddings; and
determining, by the requirements extraction device, a set of requirement classes and a set of confidence scores for each of the plurality of sentences, based on the plurality of features, using a set of classification models, wherein the set of classification models comprise at least one of a pattern recognition model, an ensemble model, or a deep learning model; and
deriving, by the requirements extraction device, a final requirement class and a final confidence score for each of the plurality of sentences based on the set of requirement classes and the set of confidence scores for each of the plurality of sentences corresponding to the set of classification models; and
providing, by the requirement extraction device, the software development requirements based on the final requirement class and the final confidence score for each of the plurality of sentences.

2. The method of claim 1, further comprising:
receiving the natural language information from a plurality of sources in a plurality of data format, wherein the plurality of data format comprises at least one of a video format, an audio format, a document format, or a text format;
standardizing the natural language information in a pre-defined text format to generate natural language text information, wherein standardizing comprises at least one of a video-to-audio extraction, an audio-to-text conversion, or a text-to-text conversion; and
pre-processing the natural language text information to generate the structured text data, wherein the pre-processing comprises at least one of a text cleaning process, a text standardization process, a text normalization process, a contradiction removal process, an abbreviation removal process, or a named entity replacement process.

3. The method of claim 1, wherein extracting the plurality of features comprises at least one of:
identifying the token based patterns in each of the plurality of sentences using at least one of regular expressions, tokens regex, or part of speech (PoS) tags;
generating the unique words frequency by building a frequency matrix for each of a plurality of unique words in each of the plurality of sentences; or
generating the word embeddings by representing each of a plurality of words in each of the plurality of sentences in a n-dimensional vector space.

4. The method of claims 1, wherein determining the set of requirement classes and the set of confidence scores for each of the plurality of sentences comprises at least one of:
applying the pattern recognition model on the token based patterns;
applying the ensemble model on the unique words frequency; or
applying the deep learning model on the word embeddings.

5. The method of claim 1,
wherein the pattern recognition model comprises at least one of a knowledge based pattern recognition model and a rule based pattern recognition mode;
wherein unique words frequency comprises a term frequency-inverse document frequency (TF-IDF);
wherein the ensemble model comprises at least one of a random forest model, an XGBoost model, or an artificial neural network (ANN) model; and
wherein the deep learning model is at least one of an attention-based long short-term memory (LSTM) model, a LSTM model, or a recurrent neural network (RNN) model.

6. The method of claim 1, wherein each of the set of requirement classes comprises one of a functional class, a technical class, a business class, or a non-requirement class.

7. The method of claim 1, wherein the final confidence score for the sentence is derived as one of:
a weighted average of the set of confidence scores corresponding to the set of classification models, wherein each of The set of confidence scores is assigned a pre-defined weightage or a user-defined weightage;: and
a score of an artificial neural network (ANN) model based on the set of confidence scores corresponding to the set of classification models.

8. The method of claim 1, further comprising:
determining at least one of a contextual relatedness score and a semantic relatedness score for each of the plurality of sentences not classified as the software development requirements with respect to a set of neighbouring sentences classified as the software development requirements; and
grouping one or more of the plurality of sentences not classified as the software development requirements with one or more of the set of neighbouring sentences classified as the software development requirements based on at least one of their contextual relatedness score and their semantic relatedness score.

9. The method of claim 8, wherein determining the at least one of a contextual relatedness score and a semantic relatedness score between two sentences comprises, on word embeddings of each of the two sentences, applying at least one of a Cosine Similarity algorithm, a Word Mover Distance algorithm, a Universal Sentence Encoder algorithm or a Siamese Manhattan LSTM algorithm.

10. A system for extracting software development requirements from natural language information, the system comprising:
a processor; and
a computer-readable medium communicatively coupled to the processor, wherein the computer-readable medium stores processor-executable instructions, which when executed by the processor, cause the processor to:
receive structured text data related to a software development, wherein the structured text data is derived from natural language information;
extract a plurality of features for each of a plurality of sentences in the structured text data, wherein the plurality of features comprise at least one of token based patterns, unique words frequency, or word embeddings; and
determine a set of requirement classes and a set of confidence scores for each of the plurality of sentences, based on the plurality of features, using a set of classification models, wherein the set of classification models comprise at least one of a pattern recognition model, an ensemble model, or a deep learning model; and
derive a final requirement class and a final confidence score for each of the plurality of sentences based on the set of requirement classes and the set of confidence scores for each of the plurality of sentences corresponding to the set of classification models; and
provide the software development requirements based on the final requirement class and the final confidence score for each of the plurality of sentences.

11. The system of claim 10, wherein the processor-executable instructions, on execution, further cause the processor to:
receive the natural language information from a plurality of sources in a plurality of data format, wherein the plurality of data format comprises at least one of a video format, an audio format, a document format, or a text format;
standardize the natural language information in a pre-defined text format to generate natural language text information, wherein standardizing comprises at least one of a video-to-audio extraction, an audio-to-text conversion, or a text-to-text conversion; and
pre-process the natural language text information to generate the structured text data, wherein the pre-processing comprises at least one of a text cleaning process, a text standardization process, a text normalization process, a contradiction removal process, an abbreviation removal process, or a named entity replacement process.

12. The system of claim 10, wherein extracting the plurality of features comprises at least one of:
identifying the token based patterns in each of the plurality of sentences using at least one of regular expressions, tokens regex, or part of speech (PoS) tags;
generating the unique words frequency by building a frequency matrix for each of a plurality of unique words in each of the plurality of sentences; or
generating the word embeddings by representing each of a plurality of words in each of the plurality of sentences in a n-dimensional vector space.

13. The system of claim 10, wherein determining the set of requirement classes and the set of confidence scores for each of the plurality of sentences comprises at least one of:
applying the pattern recognition model on the token based patterns;
applying the ensemble model on the unique words frequency; or
applying the deep learning model on the word embeddings.

14. The system of claim 10,
wherein the pattern recognition model comprises at least one of a knowledge based pattern recognition model and a rule based pattern recognition mode;
wherein unique words frequency comprises a term frequency-inverse document frequency (TF-IDF);
wherein the ensemble model comprises at least one of a random forest model, an XGBoost model, or an artificial neural network (ANN) model; and
wherein the deep learning model is at least one of an attention-based long short-term memory (LSTM) model, a LSTM model, or a recurrent neural network (RNN) model.

15. The system of claim 10, wherein the final confidence score for the sentence is derived as one of:
a weighted average of the set of confidence scores corresponding to the set of classification models, wherein each of the set of confidence scores is assigned a pre-defined weightage or a user-defined weightage; and
a score of an artificial neural network (ANN) model based on the set of confidence scores corresponding to the set of classification models.

16. The system of claim 10, wherein the processor-executable instructions, on execution, further cause the processor to:
determine at least one of a contextual relatedness score and a semantic relatedness score for each of the plurality of sentences not classified as the software development requirements with respect to a set of neighbouring sentences classified as the software development requirements; and
group one or more of the plurality of sentences not classified as the software development requirements with one or more of the set of neighbouring sentences classified as the software development requirements based on at least one of their contextual relatedness score and their semantic relatedness score.

17. The system of claim 16, wherein determining the at least one of a contextual relatedness score and a semantic relatedness score between two sentences comprises, on word embeddings of each of the two sentences, applying at least one of a Cosine Similarity algorithm, a Word Mover Distance algorithm, a Universal Sentence Encoder algorithm or a Siamese Manhattan LSTM algorithm.

18. A non-transitory computer-readable medium storing computer-executable instructions for extracting software development requirements from natural language information, the computer-executable instructions configured for:
receiving structured text data related to a software development, wherein the structured text data is derived from natural language information;
extracting a plurality of features for each of a plurality of sentences in the structured text data, wherein the plurality of features comprise at least one of token based patterns, unique words frequency, or word embeddings; and
determining a set of requirement classes and a set of confidence scores for each of the plurality of sentences, based on the plurality of features, using a set of classification models, wherein the set of classification models comprise at least one of a pattern recognition model, an ensemble model, or a deep learning model; and
deriving a final requirement class and a final confidence score for each of the plurality of sentences based on the set of requirement classes and the set of confidence scores for each of the plurality of sentences corresponding to the set of classification models; and
providing the software development requirements based on the final requirement class and the final confidence score for each of the plurality of sentences.

19. The non-transitory computer-readable medium of claim 18, wherein the computer-executable instructions are further configured for:
receiving the natural language information from a plurality of sources in a plurality of data format, wherein the plurality of data format comprises at least one of a video format, an audio format, a document format, or a text format;
standardizing the natural language information in a pre-defined text format to generate natural language text information, wherein standardizing comprises at least one of a video-to-audio extraction, an audio-to-text conversion, or a text-to-text conversion; and
pre-processing the natural language text information to generate the structured text data, wherein the pre-processing comprises at least one of a text cleaning process, a text standardization process, a text normalization process, a contradiction removal process, an abbreviation removal process, or a named entity replacement process.

20. The non-transitory computer-readable medium of claim 18, wherein the computer-executable instructions are further configured for:
determining at least one of a contextual relatedness score and a semantic relatedness score for each of the plurality of sentences not classified as the software development requirements with respect to a set of neighbouring sentences classified as the software development requirements; and
grouping one or more of the plurality of sentences not classified as the software development requirements with one or more of the set of neighbouring sentences classified as the software development requirements based on at least one of their contextual relatedness score and their semantic relatedness score.
